(19) United States
(12) Patent Application Publication
(10) Pub. No.: US 2026/0280474 A1
(43) Pub. Date: Sep. 17, 2026

(54) Multifunctional fastener for photovoltaic modules and methods therefor

(71) Applicant: Alliance for Energy Innovation, LLC, Golden, CO (US)

(72) Inventor: David Levi YOUNG, Golden, CO (US)

(21) Appl. No.: 19/567,995

(22) Filed: Mar. 16, 2026

Related U.S. Application Data
(60) Provisional application No. 63/771,886, filed on Mar. 14, 2025.

(51) Int. Cl. H02S 30/00

(52) U.S. Cl. CPC H02S 30/00

(57) ABSTRACT

Described herein are devices and methods for the securing of outer transparent panels and photovoltaic cells within a photovoltaic module. The described devices and methods utilize configured fastener devices to allow for a clamping force to safely and securely hold the transparent panels and individual cells within the module or array in place while removing the need for lamination.

### CROSS-REFERENCE TO RELATED APPLICATIONS

This application claims priority from U.S. Provisional Patent Application No. 63/771,886, filed on Mar. 14, 2025, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Many modern glass-glass photovoltaic modules utilize polymers to laminate the components, specifically the individual solar cells, to keep them in position between the two glass outer layers. Commonly used polymers such as EVA (Ethylene-Vinyl-Acetate), POE (Poly-Octene-Ethylene) and PVB (Poly-Vinyl-Butyral) yellow over time causing decreased current generation and allow moisture to ingress into the modules which can cause corrosion of the metal/semiconductor contacts. In addition, elements in the glass (Na) may diffuse through the laminate materials and into the semiconductor when high voltage exists between the cells and frame (~1000-1500 V) which can cause degradation of the solar cell (Potential induced degradation (PID)). Laminates can also degrade by delaminating from each other or from the glass over time. The laminate materials are expensive, and the process of laminating is energy and time intensive.

Lamination also causes issues with repair, recycling and disposal of photovoltaic modules. In particular, the cells are permanently glued or bonded to one another within the module via the laminate, so replacement of cells or removal of the laminate prior to recycling/disposal of module is cost prohibitive or impossible.

It can be seen from the foregoing that there remains a need in the art for securing photovoltaic cells within glass-glass modules that remove the need for lamination. This improvement increases cell lifetime, reduces efficiency drops associated with lamination, reduces production costs and allows for the facile recycling or disposal of end of life photovoltaic modules.

### SUMMARY

Described herein are devices and methods for the securing of outer transparent panels and photovoltaic cells within a photovoltaic module. The described devices and methods utilize configured fastener devices to allow for a squeezing or clamping force to safely and securely hold the transparent panels and individual cells within the module or array in place while removing the need for lamination.

In an aspect, provided is a device comprising: a) a fastener body; b) an upper tab and a lower tab both physically connected to the fastener body; c) a sealing ring positioned between the upper tab and the lower tab and physically connected to the fastener body; and d) a plurality of connectors extending from and physically attached to the sealing ring.

In an aspect, provided is a device comprising: a) a fastener comprising: i) a fastener body; ii) an upper tab and a lower tab both physically connected to the fastener body; iii) a sealing ring positioned between the upper tab and the lower tab and physically connected to the fastener body; and iv) a plurality of connectors extending from and physically attached to the sealing ring; b) a first transparent panel positioned between the upper tab and the sealing ring of the fastener; c) a second transparent panel positioned between the sealing ring and the lower tab of the fastener; d) at least one photovoltaic cell positioned between the first transparent panel and the second transparent panel; e) a frame and f) a means for providing a clamping force to the first transparent panel and the second transparent panel; wherein the upper tab is positioned between the frame and the first transparent panel and the lower tab is positioned between the frame and the second transparent panel.

In an aspect, provided is a method comprising: a) providing a fastener comprising: i) a fastener body; ii) an upper tab and a lower tab both physically connected to the fastener body; iii) a sealing ring positioned between the upper tab and the lower tab and physically connected to the fastener body; and iv) a plurality of connectors extending from and physically attached to the sealing ring; b) positioning a first transparent panel between the upper tab and the sealing ring; c) positioning a second transparent panel between the sealing ring and the lower tab; d) positioning at least one photovoltaic cell between the first and second transparent panels; and e) applying a clamping pressure to the upper tab and lower tab.

The fastener may be a single, continuous piece, for example, formed from a pliable extruded material that is connected end-to-end to form a continuous seal around the glass sheets including as a single piece or ring. Examples of useful materials include rubbers, metals and polymers, including Teflon (polytetrafluoroethylene) PKM, Viton, ethylene propylene diene monomer (EPDM) or a combination thereof. The fastener may also be modular (i.e., formed of several different pieces such as a top, bottom and sides) in order to make assembly of the photovoltaic module easier.

The sealing ring is designed to form a seal between the two glass sheets when a clamping or squeezing force is applied. The connectors are attached to the fastener body on the inside of the sealing ring and extend inward toward the cells. The connectors may be corrugated and have a small notch or wire slot at the end of the connector length that can attach to the busbar wires between the cells in the array. These connectors are formed around the fastener touching the cell array from all four side in the Y-Z plane to provide a slight pulling force on the array from all directions to help keep the array centered between the glass sheets. Other configurations could include a slight push from all the connectors on the cell array to accomplish the same centering goal. The connectors may also be physically bonded, such as using an adhesive, to the individual cells or the connecting busbar wires. There may be a plurality of sealing rings positioned in series and extending from the fastener body.

The sealing ring(s) is provided to seal between the two transparent sheets and provide spacing between the two transparent (glass) panels when a clamping force is applied. Various cross-sectional shapes may be useful including circles/ellipses, rectangles, C-shapes or polyhedrons. The sealing ring may surround and form seals to wires to form electrical feedthroughs. The wires may connect to create a means for wires to pass through the fastener to allow for electrical connection between the individual cells and various terminals, for example, an electrical junction box for the module.

The fasteners may be size configured to fit various photovoltaic module configurations. For example, the fastener may have a height (as defined by the distance between the top of the upper tab and the bottom of the lower tab when viewed in cross-section) selected from the range of 8 mm to 30 mm, 20 mm to 200 mm, 35 mm to 100 mm, or 35 mm to 75 mm. The height, radius or effective radius of the sealing ring may be selected from the range of 0.1 mm to 1 mm, 1 mm to 5 mm, 5 mm to 20 mm, or optionally, greater than or equal to 0.3 mm or 0.5 mm. The length of the fastener and connector (the distance from the fastener body to the end of the connector, perpendicular to the height) may be greater than or equal to 5 mm, 10 mm, 30 mm, 40 mm, 100 mm or optionally 200 mm.

The transparent panels may comprise or consist essentially of glass. The described devices and methods may not require lamination.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 provides a cross-sectional schematic of an exemplary fastener.

FIG. 2 provides a cross-section schematic of an exemplary fastener illustrating that multiple sealing rings can be provided for additional support and sealing.

FIG. 3 provides a cross-sectional schematic of the exemplary fastener in FIG. 1 illustrating the interaction with the transparent panels and frame.

FIG. 4 provides a cross-sectional schematic of the exemplary fastener in FIG. 1 illustrating the interaction between the connector and the photovoltaic cells.

FIGS. 5A-5C provide a closer view of the interaction between the connector and the photovoltaic cells and/or busbar wires.

FIG. 6 provides a top down schematic of an exemplary photovoltaic module.

FIGS. 7A-7B provide a cross-sectional schematic illustrating the wiring may pass through the fastener to a junction box, which can be part of the fastener or a separate element.

FIG. 8 provides a three dimensional representation of the fastener system described herein.

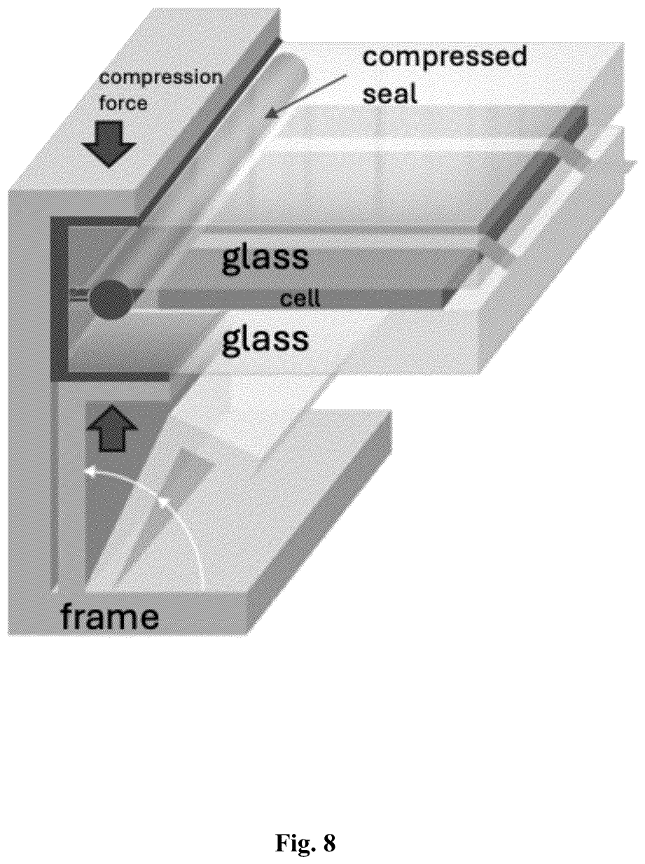

FIG. 9 shows the degradation of a traditional solar module over time, illustrating that degradation of the antireflective coating on the glass, discoloration of the encapsulant (e.g. EVA) and delamination, cracked cell isolation are the primary drivers of early failure

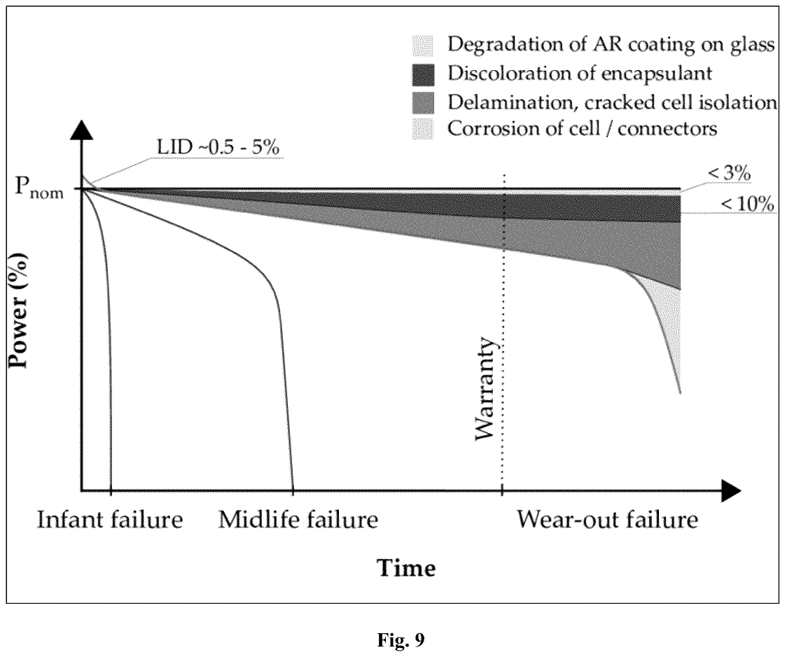

FIG. 10 compares a traditional solar module utilizing EVA sealant and a non-EVA module enabled by the present application, wherein air exists in the spacing between the glass layers.

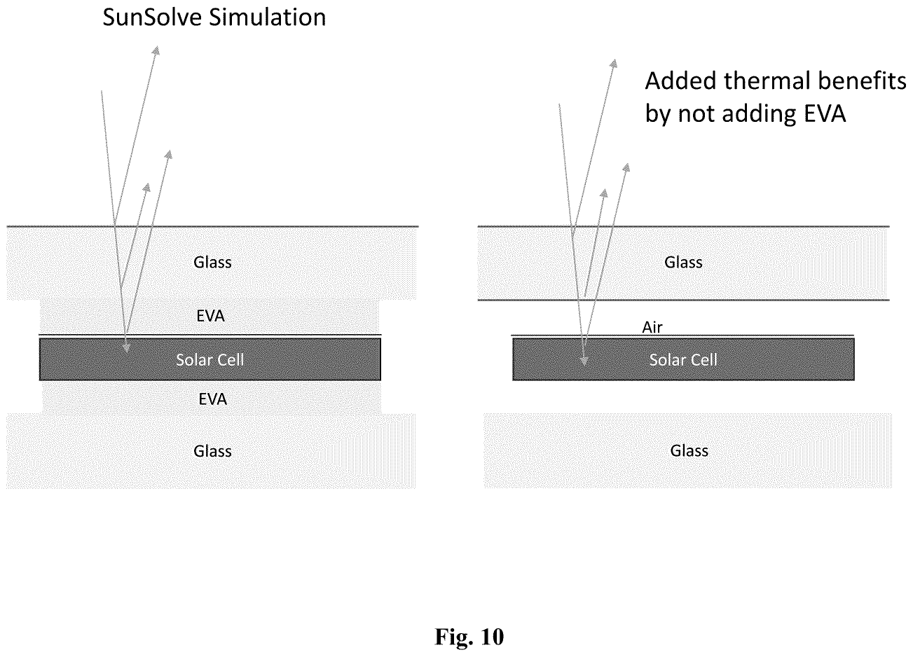

FIG. 11 illustrates the difference in cell temperature (y-axis) with gap thickness (x-axis) for both EVA and non-EVA cells, showing that for smaller gaps (approx. less than 100 μm) cell operating temperature is reduced in non-EVA cells.

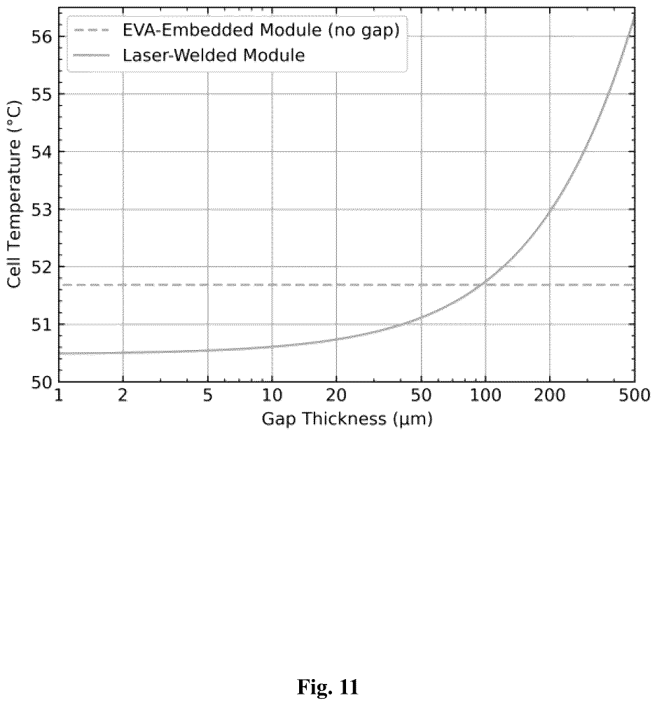

FIG. 12 provides module voltage (x-axis) and module current (y-axis) for both EVA and non-EVA solar modules.

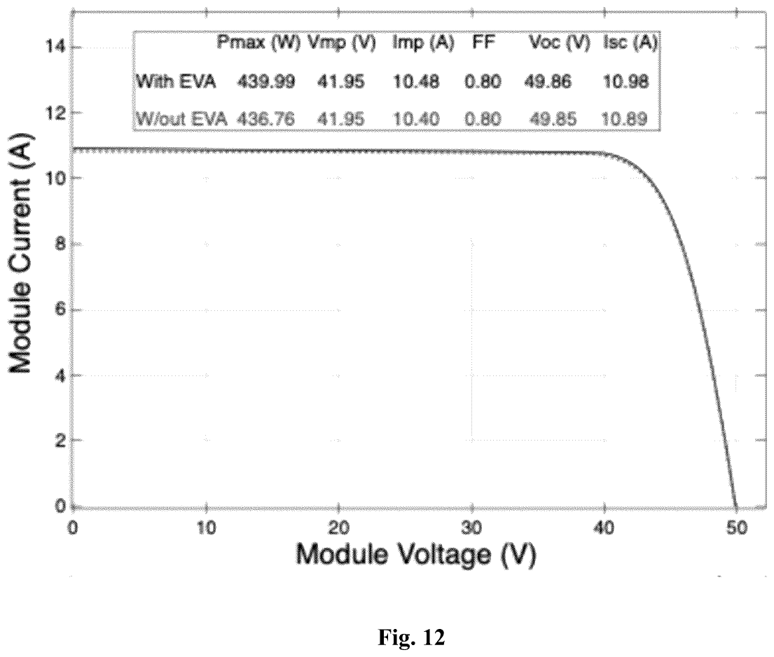

FIG. 13 provides external quantum efficiency (y-axis) at various electromagnetic wavelengths (x-axis) for both EVA and non-EVA solar cells.

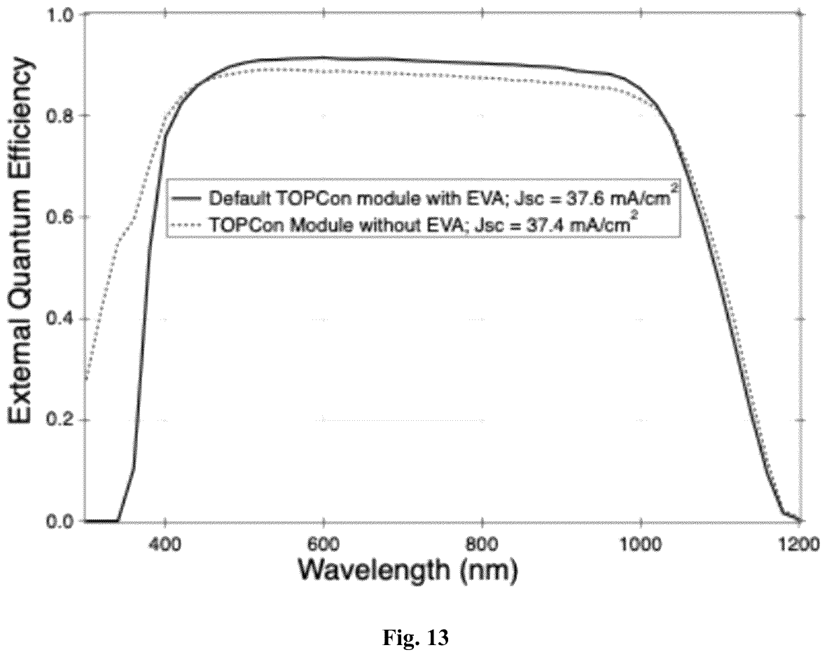

FIG. 14 provides solar module voltage and current before and after dynamic mechanical acceleration exposure at 450 Pa at 10 hz for one million cycles for a non-EVA module, illustrating that the current density-voltage (JV) was not effected.

### REFERENCE NUMERALS

100 Fastener
110 Tab (upper)
120 Tab (lower)
130 Sealing ring
140 Connector
150 Wire slot
200 Frame
210 Glass sheets
300 Electrical junction
310 Wiring
320 Photovoltaic cell
330 Wire Fastener

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

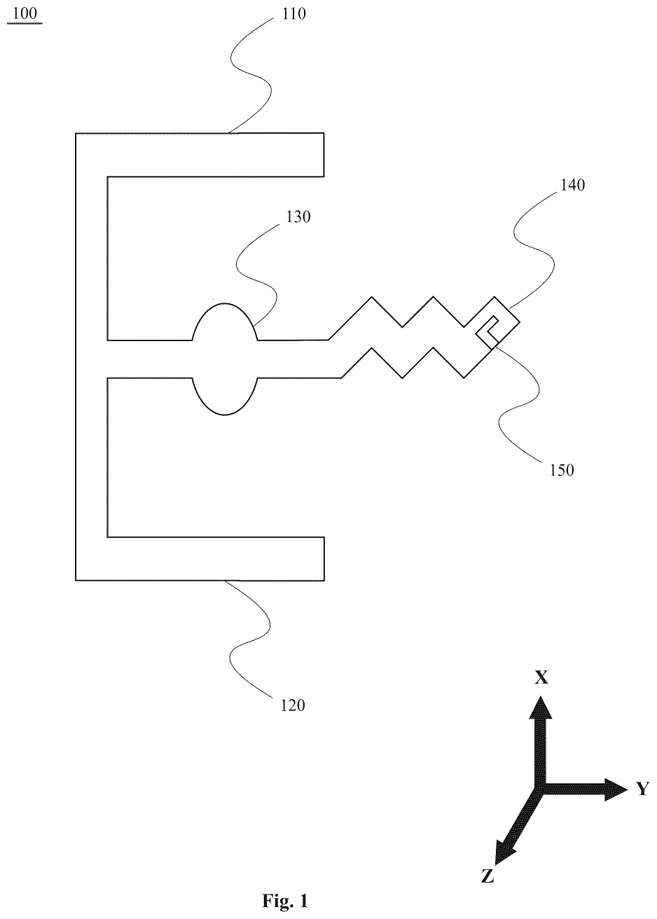

As used herein, the term “height” refers to the directional dimension of the fastener from the top of the upper tab to the bottom of the lower tab, as illustrated by the x-axis in FIGS. 1-4.

As used herein, the term “lateral” or “laterally” refers to the direction perpendicular to the height, as illustrated by the y-and z-axis in FIGS. 1-4.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

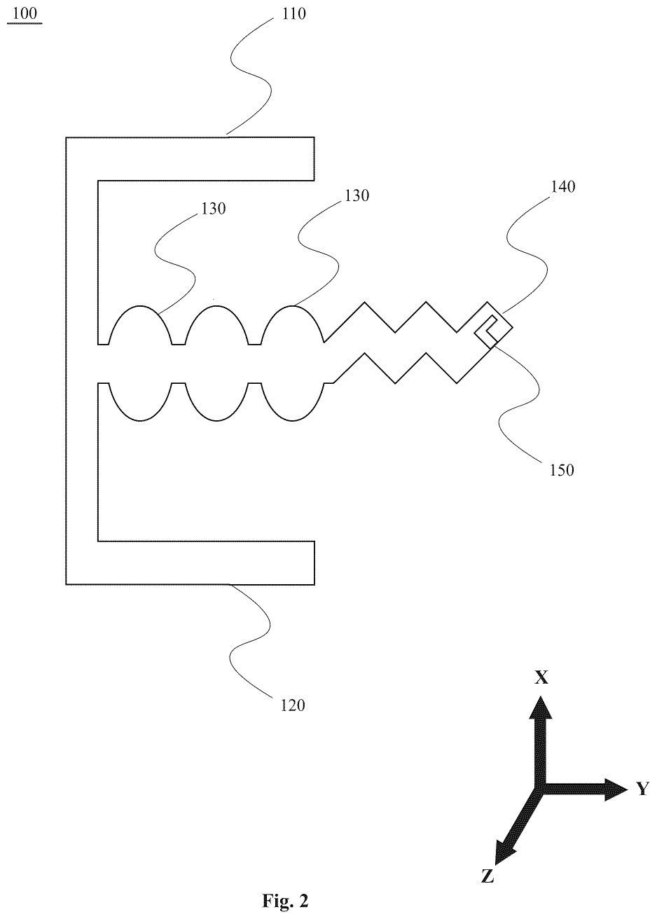

FIG. 1 provides an example cross-sectional schematic of a fastener 100 to position and support glass sheets in a glass-glass photovoltaic module. The fastener has two tabs (upper 110 and lower 120) that can be positioned between the frame and the glass sheets, and a clamping or squeezing force to be applied from the frame to secure the sheets in position. The sealing ring 130 is a deformable shape that is used to form a seal between the glass sheets and to separate the two glass sheets and provide spacing and protection for photovoltaic cells positioned between the two glass sheets. The connector 140 is used to provide lateral stability (in the y and z directions as shown in FIG. 1) within the module by connecting to or providing a slight force (push or pull) on individual photovoltaic cells or connecting busbar wires within the module. The wire slot 150 may be used as a connection point to the busbar wires between individual cells. FIG. 2 provides a similar cross-sectional schematic utilizing a plurality of sealing rings 130 positioned in series and extending from the fastener body, which may be useful in providing additional support between the two glass sheets and the frame of a photovoltaic module and to provide a more robust barrier to the elements from entering between the glass panels. In some embodiments, such as thin-film photovoltaic modules, the ring does not require a connector for lateral stability.

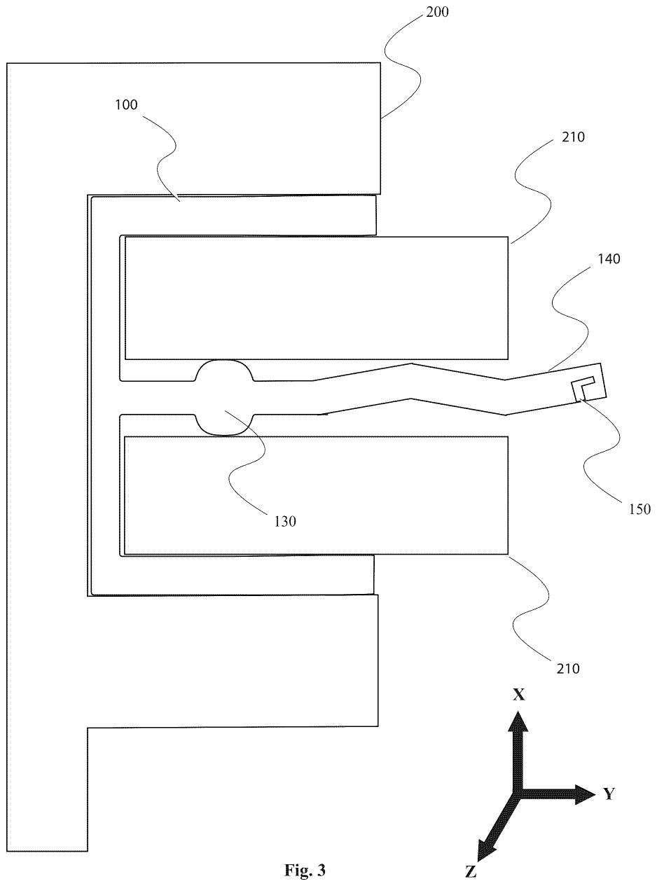

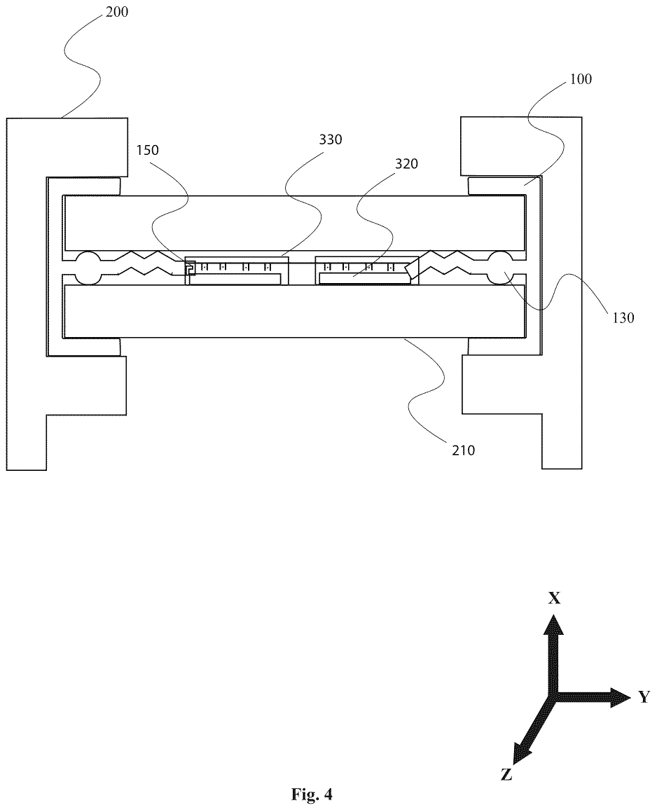

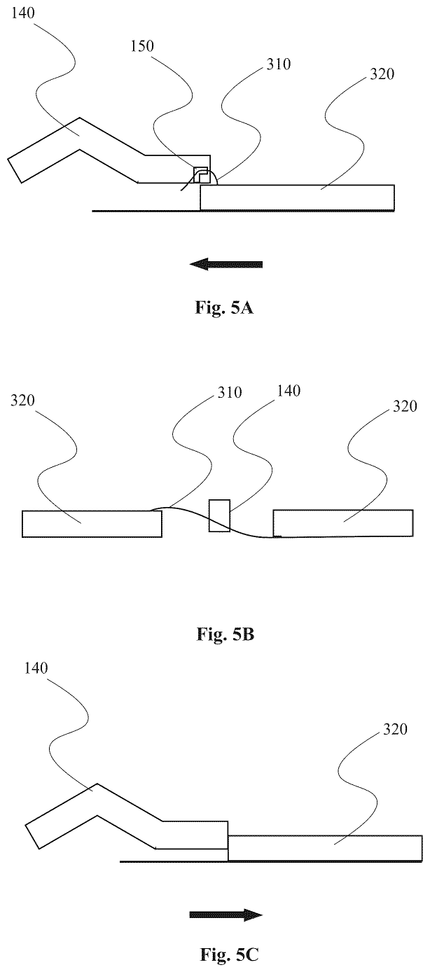

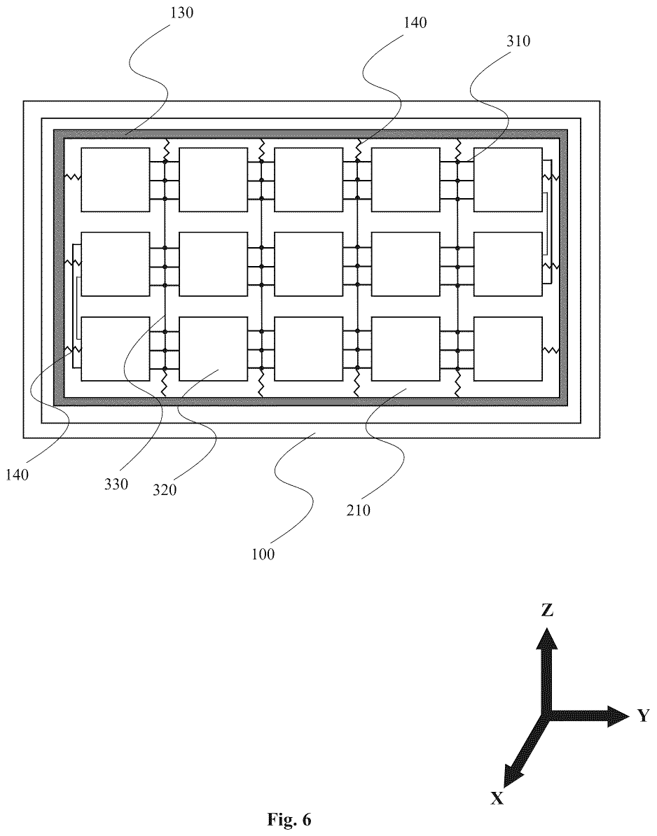

FIG. 3 provides a cross-sectional schematic of the fastener 100 interacting with the frame 200 and the glass sheets 210. A squeezing force may be applied to the two glass sheets 210 (downward on the top glass sheet and upwards on the bottom glass sheet). The fastener 100 provides a hermetic seal between the glass sheets 210 and distributes the force and separates the hard metal frame material from the glass sheet to reduce the risk of damaging, scratching, or cracking the glass sheets 210. The sealing ring is compressed between the two glass sheets 210 to provide a seal, spacing and stability. FIG. 4 shows the individual photovoltaic cells 320 proximate to the lower glass sheet 210. The connectors 140 can be in physical contact with the cells 320 to hold them in position, including by attaching the wire slot 150 to busbar wires between the solar cells 320 (as shown on the left cell in FIG. 4). The right cell 320 in FIG. 4 is shown being pushed to the left by connector 130. The cells 320 can be held in position by the force applied by the connector 140, for example, if the connectors are corrugated and clipped to the cells 320 the cell array is held in place from moving laterally in the Y-Z plane, as illustrated in FIGS. 5A-5C. The spacing between the cells is maintained by the soldered busbars between the cells. Alternatively, the connectors 140 can be physically attached to the cells 320, for example, by using an adhesive or the wire slot 150. The connectors 140 from multiple attachment points around the sealing ring of the fastener 100 can also be attached to the cells via friction, hooks, adhesives, etc. The arrows in FIGS. 5A and 5C illustrate the direction of force being applied by the connector 140 onto the cell 320. A wire fastener 330 may also be employed to enhance the stability of the solar cell, as shown in FIGS. 4 and 6.

FIG. 6 provides a top-down view of photovoltaic cells 320 arranged in an array as commonly found in photovoltaic modules. The cells 320 are in between two glass sheets 210 and the fastener 100 is positioned around the perimeter of glass sheets 210. As described in FIGS. 1-5, the sealing ring(s) 130 provide sealing, spacing and support in the vertical direction (the x direction of the figure) and the connectors 140 provide lateral support to the array of photovoltaic cells 320 (in the y and z directions). Solely for the purpose of illustration, the connectors 140 along the top are connected to the busbar wires 310 applying a pulling force and the connectors 140 along the side are pushing on the solar cell 320. However, it can be understood that various configurations may be used, including alternating pushing and pulling connectors in order to maintain the lateral stability of the cells.

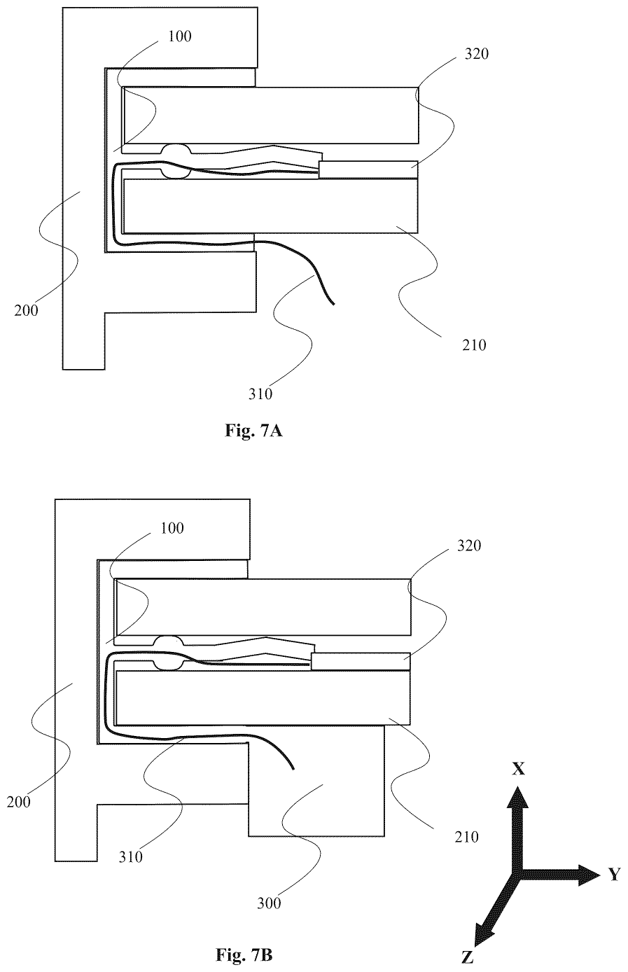

The sealing ring 130 may also form a seal around a pass through wire 310 as illustrated in FIG. 7A. Wiring 310 can be run through the sealing ring 130 and through the body of the fastener 100 outside of the glass enclosure formed by the two glass sheets 210. For example, the wiring 310 may placed into the fastener 100 while it is being heated and formed and held in place while the fastener 100 is allowed to cool and harden around the wiring. A junction box 300 can also be incorporated into the fastener 100 as shown in FIG. 7B and act as a terminal point for the wiring 310. The junction box 300 can also be part of the connector 140 or a separate feature than the fastener 100.

Additional examples of materials that would be useful as materials for the fastener include fluoropolymers such as FPM (fluorine containing synthetic rubber) and Viton, ethylene propylene diene monomer (EPDM), polytetrafluoroethylene (e.g. Teflon). Mixtures of these materials may also be employed to optimize gas and water vapor permeability, compression set and UV resistance.

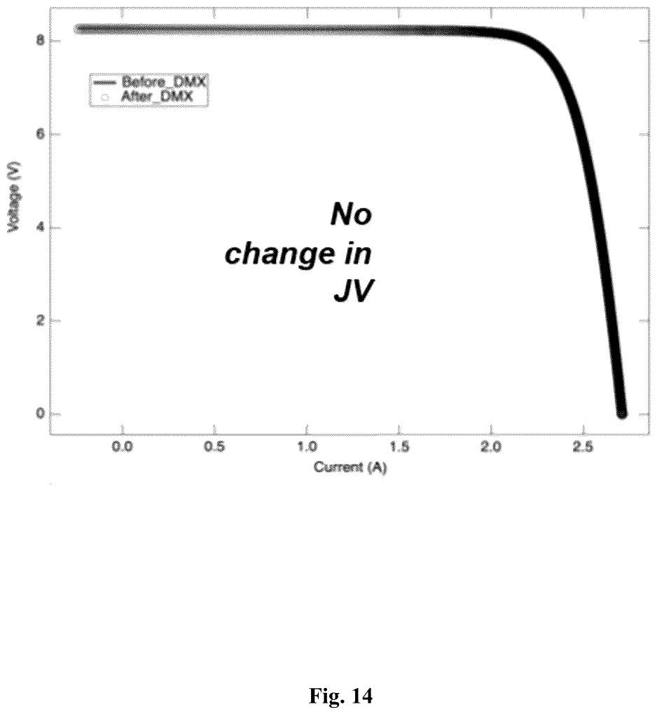

FIG. 14 provides current density-voltage results from dynamic mechanical acceleration testing (DMX) exposure of 450 Pa at 10 hz for one million cycles, illustrating the robustness of the described faster system. Current density-voltage of the reference module (8, ½ minimodule with a PIB seal with a 1 mm spacer between the glass-glass surfaces 0 did not change after the DMX testing. For reference, the windiest hour experience over a one-year period in Golden, CO would result in a 212 Pa pressure amplitude for approximately 11 thousand cycles. Therefore, the test represents an exposure of roughly twice that windspeed for the equivalence of 90 years.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A device comprising:
a fastener body;
an upper tab and a lower tab both physically connected to the fastener body;
a sealing ring positioned between the upper tab and the lower tab and physically connected to the fastener body; and
a plurality of connectors extending from and physically attached to the sealing ring.

2. The device of claim 1, wherein the fastener body, the upper tab, the lower tab, the sealing ring and the connectors are a single, continuous piece.

3. The device of claim 1, wherein the device is formed via extrusion, ram extrusion, paste extrusion, compression molding, CNC machining, thermoforming or a combination thereof.

4. The device of claim 1, wherein the device comprises a rubber, a polymer, a metal or a combination thereof.

5. The device of claim 1, wherein the device comprises Teflon (polytetrafluoroethylene), PKM, Viton, ethylene propylene diene monomer (EPDM) or a combination thereof.

6. The device of claim 1, wherein the connectors are corrugated.

7. The device of claim 1, wherein the sealing ring has a cross-sectional shape selected from an ellipse, a C-shape, a triangle, a cube or a polyhedron.

8. The device of claim 1, wherein the device has a height (measured as the distance between the bottom of the lower tab and top of the upper tab) selected from the range of 8 mm to 30 mm.

9. The device of claim 1, wherein the sealing ring has a height selected from the range of 0.1 mm to 10 mm.

10. The device of claim 1, wherein the sealing ring and connector extend laterally (perpendicular to the height) from the faster body a distance greater than or equal to 15 mm.

11. The device of claim 1, wherein the device is configured to secure two glass panels between the upper tab and the sealing ring and between the sealing ring and the lower tab of a photovoltaic module.

12. The device of claim 1, wherein a wire is allowed to pass through the sealing ring and forms a seal around the wire.

13. The device of claim 1, wherein the fastener body, the upper tab, the lower tab or a combination thereof allow a wire to pass through the fastener.

14. The device of claim 1 further comprising a junction box

15. A device comprising:
a fastener comprising:
a fastener body;
an upper tab and a lower tab both physically connected to the fastener body;
a sealing ring positioned between the upper tab and the lower tab and physically connected to the fastener body; and
at least one connector extending from and physically attached to the sealing ring;
a first transparent panel positioned between the upper tab and the sealing ring;
a second transparent panel positioned between the sealing ring and the lower tab;
at least one photovoltaic cell positioned between the first transparent panel and the second transparent panel;
a frame;
a means for applying a clamping force to the first transparent panel and the second transparent panel; wherein the upper tab is positioned between the clamping frame and the first transparent panel and the lower tab is positioned between the clamping frame and the second transparent panel.

16. The device of claim 15, wherein the connectors physically interact with the photovoltaic cells providing lateral stability.

17. The device of claim 15, wherein the first transparent panel, the second transparent panel, or both comprise glass.

18. A method comprising:
providing fastener comprising:
a fastener body;
an upper tab and a lower tab both physically connected to the fastener body;
a sealing ring positioned between the upper tab and the lower tab and physically connected to the fastener body; and
a plurality of connectors extending from and physically attached to the sealing ring;
positioning a first transparent panel between the upper tab and the sealing ring;
positioning a second transparent panel between the sealing ring and the lower tab;
positioning at least one photovoltaic cell between the first and second transparent panels;
applying a clamping pressure to the upper tab and lower tab.

19. The method of claim 18, wherein the first transparent panel, the second transparent panel, or both comprise glass.
